(19) United States
(12) Patent Application Publication
(10) Pub. No.: US 2008/0069404 A1
(43) Pub. Date: Mar. 20, 2008

(54) Method, system, and medium for indexing image object

(75) Inventors: Yong Lee, Yongin-si (KR); Yong Ju Jung, Yongin-si (KR); Ji Yeun Kim, Yongin-si (KR); Sang Kyun Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/651,529

(22) Filed: Jan. 10, 2007

(30) Foreign Application Priority Data
Sep. 15, 2006 (KR) 10-2006-0089783

(51) Int. Cl. G06K 9/00; G06K 9/60; G06K 9/54

(52) U.S. Cl. 382/106; 382/305

(57) ABSTRACT

A method, system, and medium for indexing an image object. The system of indexing an image object, the system includes: an image input unit receiving an image from a camera of a portable device, and displaying the received image on a display unit; a geographical object identification unit identifying a geographical object included in an object location corresponding to the image; a context information extraction unit extracting context information corresponding to the identified geographical object from a context database; and a display control unit displaying the context information on a position of the image, the position corresponding to the geographical object, and the image being displayed on the display unit.

### CROSS-REFERENCE TO RELATED APPLICATIONS

This application claims the benefit of Korean Patent Application No. 10-2006-0089783, filed on Sep. 15, 2006, in the Korean Intellectual Property Office, the disclosure of which is incorporated herein by reference.

### BACKGROUND OF THE INVENTION

1. Field of the Invention

The present invention relates to a method of indexing an image object, and more particularly, to a method, system, and medium for indexing an image object which display context information of a geographical object included in an image received from a camera of a portable device.

2. Description of the Related Art

Generally, a mobile terminal has been most widely used as a portable device. Also, as the most convenient communication device, the mobile terminal changes people's lifestyle and is established as a necessity in modern life. However, as a mobile terminal market has developed and mobile terminal technologies have been utilized in many fields, mobile terminal manufacturers are required to develop new areas of mobile terminal and differentiate mobile terminals. Also, as a variety of new services such as location information service, wireless Internet service, and the like, have appeared and many functions such as a camera and a Moving Picture Experts Group (MPEG) Audio-Layer 3 (MP3) have been installed in the mobile terminal, customer needs have been diversified. Particularly, customer needs for a terminal having more functions in a single device has been increased. The customer needs have been satisfied by an advent of devices handling multimedia data such as a digital camera, a portable multimedia player (PMP), an MP3 player, and an automotive navigation system.

In a conventional art, when users desire to obtain geographical information of a particular location, the users are required to utilize a map offline. Otherwise, the users are required to access a web site providing the geographical information via an Internet terminal, and search for the information corresponding to the particular location. However, as a function of the portable device has been gradually improved, the geographical information may be obtained by the portable device even while moving. For example, a user who is moving may acquire the geographical information of the location where the user is currently located, by using location-based services of the portable device, a search via wireless Internet, or a map data in the portable device.

However, the methods of obtaining the geographical information described above are required to perform a function of the portable device in order to acquire the geographical information. Users, in particular the elderly, may not easily use the function, since operation method is complex and tricky. Also, much time and much effort are required to retrieve the geographical information via wire/wireless Internet terminal. Moreover, critical information may be lost, since the methods described above are not performed in real time.

### SUMMARY OF THE INVENTION

An aspect of the present invention provides a method and a system of indexing an image object which receive an image from a camera of a portable device, identify a geographical object included in an object location corresponding to the image, and display context information of the geographical object of the image on a display unit in real time.

An aspect of the present invention also provides a method and a system of indexing an image object which display information of a geographical object included in an object location corresponding to an image received from a camera of a portable device on a display unit in real time, and thereby may reduce a time and effort to retrieve the information of the geographical object.

An aspect of the present invention also provides a method and a system of indexing an image object which provide text information, image information, audio information, video information, or link information as context information corresponding to a geographical object, and thereby may provide information of the geographical object in various ways.

An aspect of the present invention also provides a method and a system of indexing an image object which provide advertisement information as context information corresponding to a geographical object, and thereby may increase an efficiency of an advertisement and a promotion.

According to an aspect of the present invention, there is provided a system of indexing an image object, the system including: an image input unit receiving an image from a camera of a portable device, and displaying the received image on a display unit; a geographical object identification unit identifying a geographical object included in an object location corresponding to the image; a context information extraction unit extracting context information corresponding to the identified geographical object from a context database; and a display control unit displaying the context information on a position of the image, the position corresponding to the geographical object, and the image being displayed on the display unit.

In an aspect of the present invention, the geographical object identification unit includes spatial information sensing unit computing spatial information corresponding to the image, and estimating the object location by using at least one sensor, and a geographical object detection unit detecting the geographical object included in the estimated object location by referring to a predetermined map database.

In an aspect of the present invention, the at least one sensor includes at least any one of a location information measurement module including a global positioning system (GPS), a digital compass, a distance sensor, and a gyro sensor.

In an aspect of the present invention, the spatial information sensing unit computes at least any one of location information, pan angle information to which a lens of the camera is facing, distance information from the geographical object, information about a horizontal angle of the camera, information about a vertical angle of the camera, and camera tilt information.

According to another aspect of the present invention, there is provided a method of indexing an image object, the method including: receiving an image from a camera of a portable device, and displaying the received image on a display unit; identifying a geographical object included in an object location corresponding to the image; extracting context information corresponding to the identified geographical object from a context database; and displaying the context information on a position corresponding to the geographical object on the image.

According to an aspect of the present invention, there is provided a system of indexing an image object, the system including an image input unit to receive an image from a camera of a portable device, and displaying the received image on a display; a geographical object identifier to identify a geographical object included in an object location corresponding to the image; a context information extractor to extract context information corresponding to the identified geographical object from a context database; and a display controller to control display of the context information on a position of the image, the position corresponding to the geographical object, and the image being displayed on the display.

According to an aspect of the present invention, there is provided a method of indexing an image object, the method including receiving an image from a camera of a portable device, and displaying the received image on a display; identifying a geographical object included in an object location corresponding to the image; extracting context information corresponding to the identified geographical object from a context database; and displaying the context information on a position of the image, the position corresponding to the geographical object, and the image being displayed on the display.

According to an aspect of the present invention, there is provided a system of indexing an image object, the system including a geographical object identifier to identify a geographical object included in an object location corresponding to an image on a display; a context information extractor to extract context information corresponding to the identified geographical object from a context database; and a display controller to control display of the context information on a position of the image, the position corresponding to the geographical object, and the image being displayed on the display.

According to an aspect of the present invention, there is provided a method of indexing an image object, the method including identifying a geographical object included in an object location corresponding to an image on a display; extracting context information corresponding to the identified geographical object from a context database; and displaying the context information on a position of the image, the position corresponding to the geographical object, and the image on the display.

According to another aspect of the present invention, there is provided at least one computer readable medium storing computer readable instructions to implement methods of the present invention.

Additional aspects, features, and/or advantages of the invention will be set forth in part in the description which follows and, in part, will be apparent from the description, or may be learned by practice of the invention.

### BRIEF DESCRIPTION OF THE DRAWINGS

Aspects, features, and advantages of the invention will become apparent and more readily appreciated from the following description of exemplary embodiments, taken in conjunction with the accompanying drawings of which:

FIG. 1 is a block diagram illustrating a configuration of a system of indexing an image object according to an exemplary embodiment of the present invention;

FIG. 2 is a diagram illustrating an example of a portable device displaying an image according to an exemplary embodiment of the present invention;

FIG. 3 is a block diagram illustrating an example of a geographical object identification unit illustrated in FIG. 1;

FIG. 4 is a diagram illustrating a method of estimating an object location corresponding to an image according to an exemplary embodiment of the present invention;

FIG. 5 is a diagram illustrating an example of extracting a geographical object according to an exemplary embodiment of the present invention;

FIG. 6 is a block diagram illustrating an example of a geographical object detection unit illustrated in FIG. 3;

FIGS. 7(a), 7(b), and 8 are diagrams illustrating an example of a screen displaying context information corresponding to an object according to an exemplary embodiment of the present invention;

FIG. 9 is a diagram illustrating a process of controlling a display control unit to display context information by using a field of view of a geographical object according to an exemplary embodiment of the present invention;

FIG. 10 is a diagram illustrating another example of a screen displaying context information according to an exemplary embodiment of the present invention;

FIG. 11 is a flowchart illustrating a method of indexing an image object according to an exemplary embodiment of the present invention; and

FIG. 12 is a flowchart illustrating an example of a method of identifying a geographical object illustrated in FIG. 11.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

A portable device as used throughout the present specification includes mobile communication devices, such as a personal digital cellular (PDC) phone, a personal communication service (PCS) phone, a personal handyphone system (PHS) phone, a Code Division Multiple Access (CDMA)-2000 (1X, 3X) phone, a Wideband CDMA phone, a dual band/dual mode phone, a Global System for Mobile Communications (GSM) phone, a mobile broadband system (MBS) phone, a satellite/terrestrial Digital Multimedia Broadcasting (DMB) phone, a Smart phone, a cellular phone, a personal digital assistant (PDA), a MP3 player, a portable media player (PMP), an automotive navigation system (e.g. car navigation system), and the like. Also, the portable device as used throughout the present specification includes a digital camera, a plasma display panel, and the like.

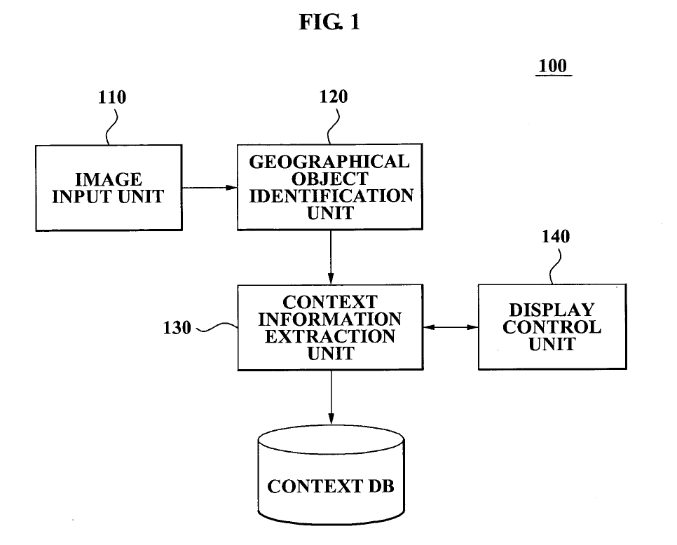

FIG. 1 is a block diagram illustrating a configuration of a system of indexing an image object according to an exemplary embodiment of the present invention.

Referring to FIG. 1, the system of indexing an image object 100 includes an image input unit 110, a geographical object identification unit (geographical object identifier) 120, a context information extraction unit (context information extractor) 130, a display control unit (display controller) 140, and a context database (DB).

The image input unit 110 receives an image from a camera of a portable device, and displays the received image on a display unit. Also, the image input unit 110 may include an image sensor such as a charge-coupled device (CCD) or a complementary metal-oxide semiconductor (CMOS).

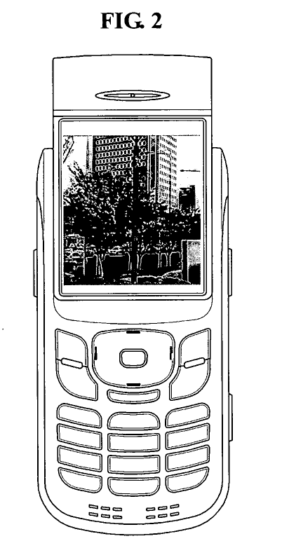

FIG. 2 is a diagram illustrating an example of a portable device displaying an image according to an exemplary embodiment of the present invention.

As illustrated in FIG. 2, a user may see, via a display unit (display), the image by operating a camera of a portable device. In this instance, the image is received from the camera of the portable device, and may include a geographical object such as a building or a road.

The geographical object identification unit 120 identifies the geographical object included in an object location corresponding to the image. The geographical object according to an exemplary embodiment of the present invention may include buildings, roads, and the like.

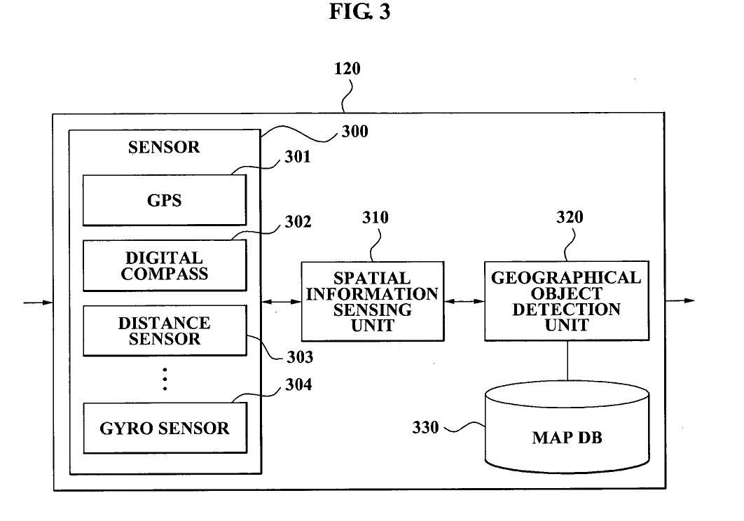

FIG. 3 is a block diagram illustrating an example of a geographical object identification unit illustrated in FIG. 1.

Referring to FIGS. 1 and 3, the geographical object identification unit 120 includes a spatial information sensing unit (spatial information sensor) 310 and a geographical object detection unit (geographical object detector) 320.

The spatial information sensing unit 310 computes spatial information corresponding to an image by using at least one sensor 300 and estimates the object location through the computed spatial information. As an example, the sensor 300 may include at least any one of a location information measurement module including at least any one of a global positioning system (GPS) 301, a digital compass 302, a distance sensor 303, and a gyro sensor 304. In this instance, the GPS 301 may receive location information such as a longitude, a latitude, and an altitude of a current location. The digital compass 302 may measure a pan angle which refers to direction information. The distance sensor 303 may measure a distance from the camera to a subject. The gyro sensor 304 may measure a camera tilt. Also, the sensor 300 may additionally include another sensor to measure the spatial information of the object location.

According to an exemplary embodiment of the present invention, the spatial information sensing unit 310 may compute at least any one of location information, pan angle information to which a lens of the camera is facing, distance information from the geographical object, information about a horizontal angle of the camera, information about a vertical angle of the camera, and camera tilt information.

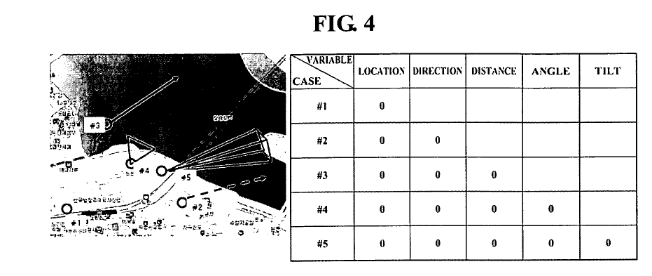

FIG. 4 is a diagram illustrating a method of estimating an object location corresponding to an image according to an exemplary embodiment of the present invention.

Referring to FIG. 4, the method of estimating an object location based on spatial information which is computed from the image is classified into five methods.

First, when location information is ascertained as the spatial information which is computed from the image by using a sensor, as illustrated in case #1 of FIG. 4, a spatial information sensing unit 310 extends a range according to a predetermined standard, based on the location information. Accordingly, the spatial information sensing unit 310 may estimate the object location.

Second, when the location information and direction information, i.e. pan angle information, are ascertained as the spatial information which is computed from the image by using the sensor, as illustrated in case #2 of FIG. 4, the spatial information sensing unit 310 may estimate the object location based on the location information and the direction information. For example, in the case #2 of FIG. 4, distance information may not be ascertained. Accordingly, a distance is required to be set by assuming the length to be a maximum distance which is available for photographing, for example, approximately 20 km.

Third, when the location information, the direction information, i.e. the pan angle information, and the distance information are ascertained as the spatial information which is computed from the image by using the sensor, as illustrated in case #3 of FIG. 4, the spatial information sensing unit 310 may estimate the object location by using the location information, the direction information, and the distance information.

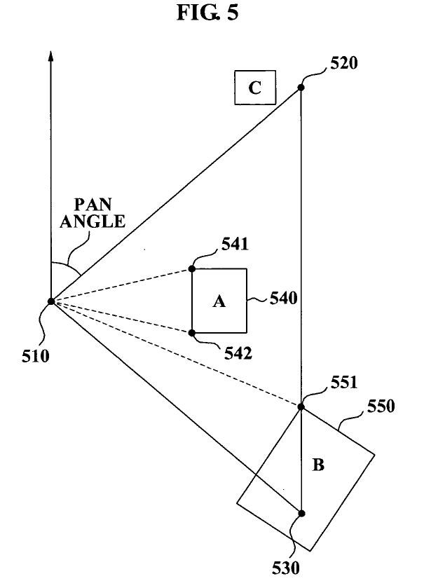

Fourth, when the location information, the direction information, i.e. the pan angle information, the distance information, and information about a horizontal angle of the camera, i.e. angle information, are ascertained as the spatial information which is computed from the image by using the sensor, as illustrated in the case #4 of FIG. 4, the spatial information sensing unit 310 may estimate the object location by using the location information, the direction information, the distance information, and the information about the horizontal angle of the camera. The method of estimating the object location in the case #4 of FIG. 4 is described in detail with reference to FIG. 5.

Fifth, when the location information, the direction information, i.e. the pan angle information, the distance information, the information about the horizontal angle of the camera, i.e. the angle information, and information about a vertical angle of the camera, and camera tilt information, i.e. tilt information, are ascertained as the spatial information which is computed from the image by using the sensor, as illustrated in case #5 of FIG. 4, the spatial information sensing unit 310 may estimate the object location by using the location information, the direction information, the distance information, the information about the horizontal angle of the camera, the information about the vertical angle of the camera, and the camera tilt information, i.e. the tilt information.

A geographical object detection unit 320 detects the geographical object included in the estimated object location by referring to a predetermined map database 330. As an example, the map database 330 may store at least any one of geographical location information, geographical distance information, geographical range information, and geographical name information. Also, the map database 330 may store and manage two-dimensional-based map data or three-dimensional-based map data.

FIG. 5 is a diagram illustrating an example of extracting a geographical object according to an exemplary embodiment of the present invention. FIG. 5 illustrates the example of extracting the geographical object included in an object location in the case #4 of FIG. 4.

Referring to FIG. 5, a geographical object detection unit 320 may identify whether the geographical object is included in the object location entirely or partially, by referring to a map database. In this instance, the object location comprises a source point 510, a left-most point 520, and a right-most point 530. The source point 510 refers to a point from where an image is taken. Specifically, the geographical object detection unit 320 may identify whether a segment of a polygon corresponding to the geographical object is included in the object location entirely or partially, since the geographical object is composed of the polygon. As an example, as illustrated in FIG. 5, the geographical object detection unit 320 may detect a geographical object (A) 540 and another geographical object (B) 550, as the geographical object included in the object location. In this instance, the geographical object (A) 540 is entirely included in the object location, and the other geographical object (B) 550 is partially included in the object location.

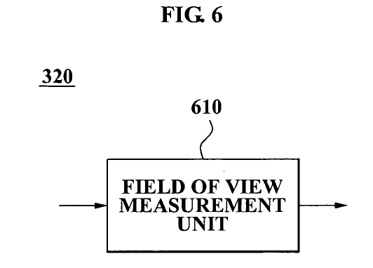

FIG. 6 is a block diagram illustrating an example of a geographical object detection unit illustrated in FIG. 3.

Referring to FIG. 6, the geographical object detection unit 320 includes a field of view measurement unit 610.

The field of view measurement unit 610 may measure field of view information of a geographical object which is detected by using spatial information.

Referring to FIGS. 5 and 6, the field of view measurement unit 610 may measure field of view information of the geographical object (A) 540 and the geographical object (B) 550 which is detected by the geographical object detection unit 320. In case of the geographical object (A) 540, the field of view measurement unit 610 may measure the field of view information of the geographical object (A) 540 by using an angle between a starting point 541 and an end point 542 of the geographical object (A) 540, in relation to the left-most point 520. In case of the geographical object (B) 550, the field of view measurement unit 610 may measure the field of view information of the geographical object (B) 550 by using an angle between a starting point 551 and an end point 530, i.e. the right-most point 530 of the object location, of the geographical object B 550. In this instance, the starting point 551 corresponds to an intersection point of a line and the geographical object B 550, and the line connects the left-most point 520 and the right-most point 530. Also, the field of view measurement unit 610 may transfer the field of view information of the measured geographical object as a list to a display control unit. In this instance, the list may include a starting angle, an end angle, and a geographical object name.

Referring again to FIG. 1, the context information extraction unit 130 extracts context information corresponding to the identified geographical object from a context database. As an example, the context information may include a geographical object name, real estate information, advertisement information, and the like, corresponding to the geographical object. The context information may include at least any one of text information, image information, video information, and audio information. Also, the context information may include link information which accesses display information of the geographical object. The context database may receive the context information from a predetermined server after every predetermined period of time, and thereby may update the context information.

A display control unit 140 displays the context information on a position of the image. In this instance, the position corresponds to the geographical object, and the image is displayed on the display unit.

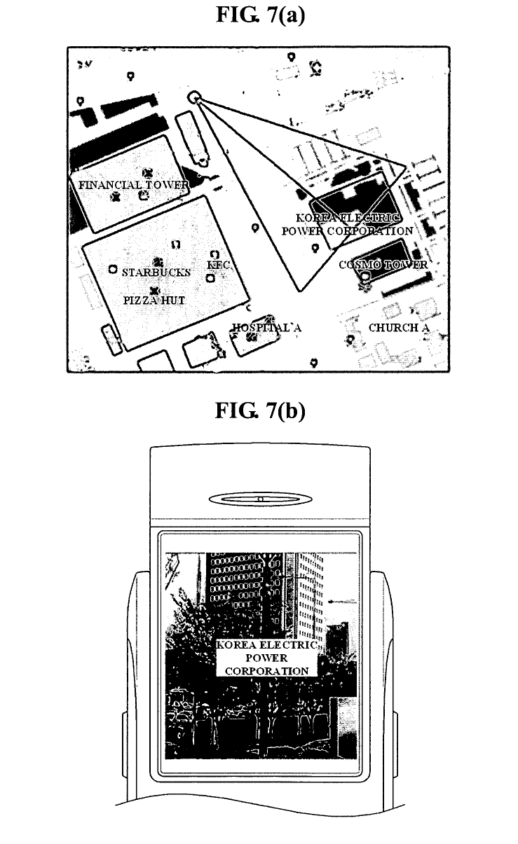

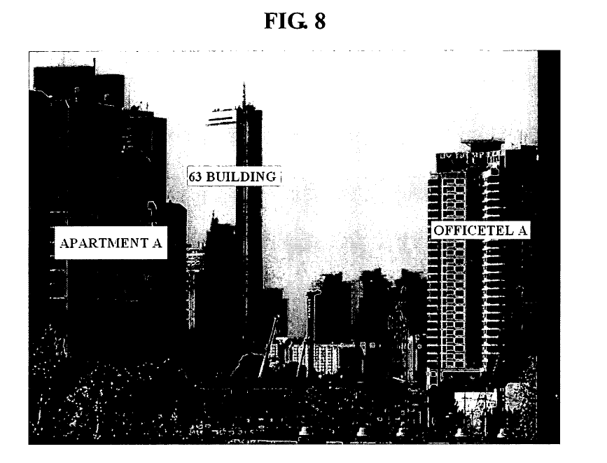

FIGS. 7(a), 7(b), and 8 are diagrams illustrating an example of a screen displaying context information corresponding to an object according to an exemplary embodiment of the present invention. A screen is an example of a display.

As illustrated in 7(a) and 7(b), a display control unit 140 may display the context information, ‘Korea Electric Power Corporation’, corresponding to a geographical object included in an object location on a map. In this instance, the display control unit 140 may display the context information on a position of an image, the position corresponding to the geographical object, and the image being displayed on the display unit of a portable device.

Also, as illustrated in 8, the display control unit 140 may display the context information, ‘Apartment A’, ‘63 building’, and ‘Officetel A’ corresponding to geographical objects on the position of each of the images, on the display unit.

According to an exemplary embodiment of the present invention, the display control unit 140 may display the context information within a field of view by using field of view information of the geographical object.

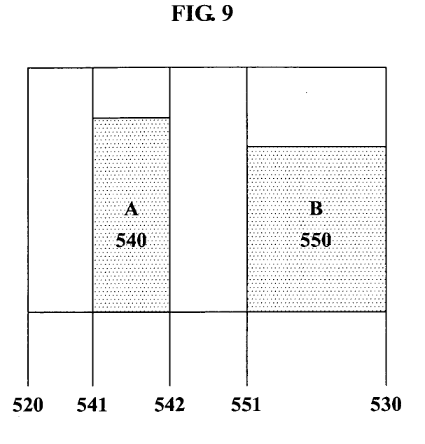

FIG. 9 is a diagram illustrating a process of controlling a display control unit to display context information by using a field of view of a geographical object according to an exemplary embodiment of the present invention.

Referring to FIGS. 5 and 9, the display control unit 140 computes a position where the context information corresponding to the geographical object is displayed on a display unit. When computing the position, field of view information of the geographical object is used. As an example, the display control unit 140 sets a size of the display unit by using the information about the horizontal angle of the camera and the information about the vertical angle of the camera. The display control unit 140 computes a position of the geographical object A 540 and the geographical object B 550 by using the field of view information of the geographical object A 540 and the geographical object B 550. In this instance, the geographical object A 540 and the geographical object B 550 are transferred from the field of view measurement unit 610, and the field of view information includes a starting angle, an end angle, and a geographical object name. Also, the display control unit 140 may control the context information of each geographical object to be displayed within the position of the computed geographical object A 540 and the geographical object B 550.

According to another exemplary embodiment of the present invention, when the geographical object is overlapped, the display control unit 140 may control the position where the context information is displayed according to a predetermined standard, and thereby may avoid the overlapping. For example, the display control unit 140 may control vertical location of the context information, and thereby may control the context information not to be overlapped.

According to still another exemplary embodiment of the present invention, the display control unit 140 accesses geographical object display information by using the link information, and control the geographical object display information to be displayed on the position corresponding to the geographical object.

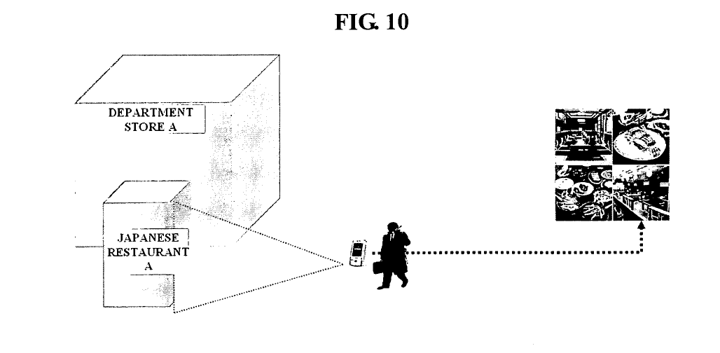

FIG. 10 is a diagram illustrating another example of a screen displaying context information according to an exemplary embodiment of the present invention.

Referring to FIG. 10, when a user operates a camera of a portable device towards a geographical object ‘Japanese restaurant A’, so that the user acquires information about the geographical object ‘Japanese restaurant A’, the display control unit 140 accesses geographical object display information by using link information. In this instance, the link information corresponds to context information corresponding to the geographical object. Also, the display control unit 140 may control the information about the geographical object ‘Japanese restaurant A’ to be displayed on the position corresponding to the geographical object. The information about the geographical object ‘Japanese restaurant A’ may include the geographical object's interior design, the geographical object's menu, and the like.

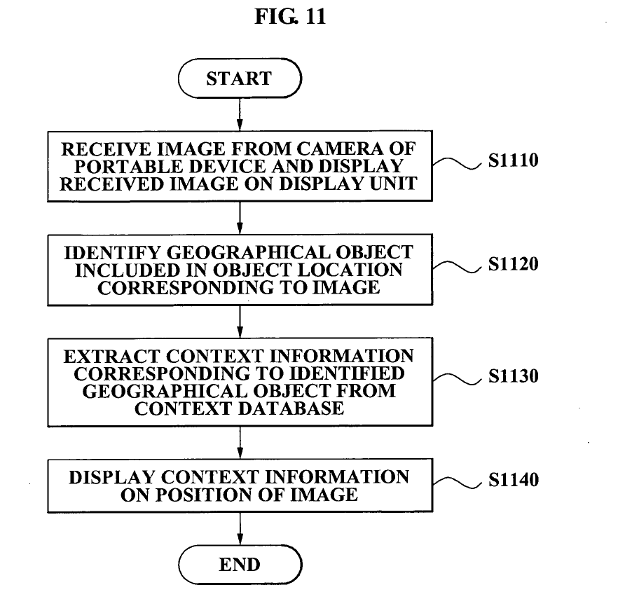

FIG. 11 is a flowchart illustrating a method of indexing an image object according to an exemplary embodiment of the present invention.

Referring to FIG. 11, in operation S1110, the method of indexing an image object receives an image from a camera of a portable device, and displays the received image on a display unit.

In operation S1120, the method of indexing an image object identifies a geographical object included in an object location corresponding to the image. In an exemplary embodiment of the present invention, the geographical object may include a building, a road, and the like.

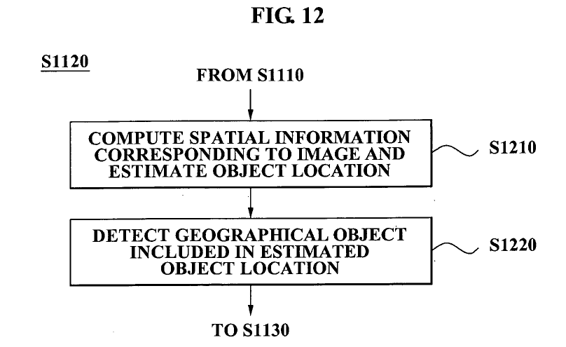

FIG. 12 is a flowchart illustrating an example of a method of identifying a geographical object illustrated in FIG. 11.

Referring to FIG. 12, in operation S1210, the method of indexing an image object computes spatial information corresponding to the image and estimates the object location by using at least one sensor 300. As an example, the sensor 300 may include at least any one of a global positioning system (GPS) module 301, a digital compass 302, a distance sensor 303, and a gyro sensor 304. In this instance, the GPS module 301 may receive location information such as a longitude, a latitude, and an altitude of a current location. The digital compass 302 may measure a pan angle which refers to direction information. The distance sensor 303 may measure a distance from the camera to a subject. A gyro sensor 304 may measure a camera tilt. Also, the sensor 300 may additionally include another sensor to measure the spatial information of the object location.

As an example of operation S1210, the method of indexing an image object may compute at least any one of location information, pan angle information to which a lens of the camera is facing, distance information from the geographical object, information about a horizontal angle of the camera, information about a vertical angle of the camera, and camera tilt information.

Also, in operation S1220, the method of indexing an image object detects the geographical object included in the object location by referring to a predetermined map database 330. As an example, the map database 330 may store at least any one of geographical location information, geographical distance information, geographical range information, and geographical name information. Also, the map database 330 may store and manage two-dimensional-based map data or three-dimensional-based map data.

According to an exemplary embodiment of the present invention, the method of indexing an image object may measure field of view information of the detected geographical object by using the spatial information.

Referring again to FIG. 11, in operation S1130, the method of indexing an image object extracts context information corresponding to the identified geographical object from a context database. As an example, the context information may include a geographical object name, real estate information, advertisement information, and the like, corresponding to the geographical object. The context information may include at least any one of text information, image information, video information, and audio information. Also, the context information may include link information which accesses display information of the geographical object. The context database may receive the context information from a predetermined server after every predetermined period of time, and thereby may update the context information.

Also, in operation S1140, the method of indexing an image object displays the context information on a position corresponding to the geographical object on the image.

As an example, the method of indexing an image object may display the context information within the field of view by using field of view information of the geographical object.

As an exemplary embodiment of the present invention, the method of indexing an image object accesses geographical object display information by using the link information and displays the geographical object display information on the position corresponding to the geographical object.

In addition to the above-described exemplary embodiments, exemplary embodiments of the present invention can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of code/instructions include both machine code, such as produced by a compiler, and files containing higher level code that may be executed by a computing device and the like using an interpreter.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, DVDs, etc.), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. Examples of storage/transmission media may include wired and/or wireless transmission media. For example, storage/transmission media may include optical wires/lines, waveguides, and metallic wires/lines, etc. including a carrier wave transmitting signals specifying instructions, data structures, data files, etc. The medium/media may also be a distributed network, so that the computer readable code/instructions are stored/transferred and executed in a distributed fashion. The medium/media may also be the Internet. The computer readable code/instructions may be executed by one or more processors. The computer readable code/instructions may also be executed and/or embodied in at least one application specific integrated circuit (ASIC) or Field Programmable Gate Array (FPGA).

In addition, one or more software modules or one or more hardware modules may be configured in order to perform the operations of the above-described exemplary embodiments.

The term “module”, as used herein, denotes, but is not limited to, a software component, a hardware component, or a combination of a software component and a hardware component, which performs certain tasks. A module may advantageously be configured to reside on the addressable storage medium/media and configured to execute on one or more processors. Thus, a module may include, by way of example, components, such as software components, application specific software component, object-oriented software components, class components and task components, processes, functions, operations, execution threads, attributes, procedures, subroutines, segments of program code, drivers, firmware, microcode, circuitry, data, databases, data structures, tables, arrays, and variables. The functionality provided for in the components or modules may be combined into fewer components or modules or may be further separated into additional components or modules. Further, the components or modules can operate at least one processor (e.g. central processing unit (CPU)) provided in a device. In addition, examples of a hardware components include an application specific integrated circuit (ASIC) and Field Programmable Gate Array (FPGA). As indicated above, a module can also denote a combination of a software component(s) and a hardware component(s).

The computer readable code/instructions and computer readable medium/media may be those specially designed and constructed for the purposes of the present invention, or they may be of the kind well-known and available to those skilled in the art of computer hardware and/or computer software.

A method and a system of indexing an image object according to the above-described exemplary embodiments of the present invention receive an image from a camera of a portable device, identify a geographical object included in an object location corresponding to the image, and display context information of the geographical object of the image on a display unit in real time.

Also, a method and a system of indexing an image object according to the above-described exemplary embodiments of the present invention display information of a geographical object included in an object location corresponding to an image received from a camera of a portable device, on a display unit in real time, and thereby may reduce a time and effort to retrieve the information of the geographical object.

Also, a method and a system of indexing an image object according to the above-described exemplary embodiments of the present invention provide text information, image information, audio information, video information, or link information as context information corresponding to the geographical object, and thereby may provide information of a geographical object in various ways.

Also, a method and a system of indexing an image object according to the above-described exemplary embodiments of the present invention provide advertisement information as context information corresponding to a geographical object, and thereby may increase an efficiency of an advertisement and a promotion.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system of indexing an image object, the system comprising:
an image input unit to receive an image from a camera of a portable device, and displaying the received image on a display;
a geographical object identifier to identify a geographical object included in an object location corresponding to the image;
a context information extractor to extract context information corresponding to the identified geographical object from a context database; and
a display controller to control display of the context information on a position of the image, the position corresponding to the geographical object, and the image being displayed on the display.

2. The system of claim 1, wherein the geographical object identifier comprises:
a spatial information sensor to compute spatial information corresponding to the image, and to estimate the object location by using at least one sensor; and
a geographical object detector to detect the geographical object included in the estimated object location by referring to a predetermined map database.

3. The system of claim 2, wherein the at least one sensor comprises at least any one of a global positioning system (GPS), a digital compass, a distance sensor, and a gyro sensor.

4. The system of claim 2, wherein the spatial information sensor computes at least any one of location information, pan angle information to which a lens of the camera is facing, distance information from the geographical object, information about a horizontal angle of the camera, information about a vertical angle of the camera, and camera tilt information.

5. The system of claim 4, wherein the geographical object detector comprises:
a field of view measurement unit to measure field of view information of the detected geographical object based on the location information, and
the display controller to control display of the context information within a field of view by using the field of view information of the detected geographical object.

6. The system of claim 2, wherein the map database stores at least any one of geographical location information, geographical distance information, geographical range information, and geographical name information.

7. The system of claim 1, wherein the context information comprises at least any one of image information, video information, and audio information.

8. The system of claim 1, wherein the context information comprises link information, and the display controller accesses geographical object display information by using the link information and displays the geographical object display information on the position corresponding to the geographical object.

9. A method of indexing an image object, the method comprising:
receiving an image from a camera of a portable device, and displaying the received image on a display;
identifying a geographical object included in an object location corresponding to the image;
extracting context information corresponding to the identified geographical object from a context database; and
displaying the context information on a position of the image, the position corresponding to the geographical object, and the image being displayed on the display.

10. The method of claim 9, wherein the identifying a geographical object comprises:
computing spatial information corresponding to the image and estimating the object location by using at least one sensor; and
detecting the geographical object included in the estimated object location by referring to a predetermined map database.

11. The method of claim 10, wherein the at least one sensor comprises at least any one of a global positioning system (GPS), a digital compass, a distance sensor, and a gyro sensor.

12. The method of claim 9, wherein the computing spatial information computes at least any one of location information, pan angle information to which a lens of the camera is facing, distance information from the geographical object, information about a horizontal angle of the camera, information about a vertical angle of the camera, and camera tilt information.

13. The method of claim 12, wherein the detecting the geographical object comprises a field of view measurement unit to measure field of view information of the detected geographical object based on the location information, and the displaying of the context information displays the context information within a field of view by using the field of view information of the detected geographical object.

14. The method of claim 10, wherein the map database stores at least any one of geographical location information, geographical distance information, geographical range information, and geographical name information.

15. The method of claim 9, wherein the context information comprises at least any one of image information, video information, and audio information.

16. The method of claim 9, wherein the context information comprises link information, and the displaying of the context information accesses geographical object display information by using the link information and displays the geographical object display information on the position corresponding to the geographical object.

17. At least one computer readable medium storing instructions that control at least one processor for implementing a method of indexing an image object, the method comprising:
receiving an image from a camera of a portable device, and displaying the received image on a display;
identifying a geographical object included in an object location corresponding to the image;
extracting context information corresponding to the identified geographical object from a context database, and
displaying the context information on a position of the image, the position corresponding to the geographical object, and the image being displayed on the display.
